(19) United States
(12) Patent Application Publication
(10) Pub. No.: US 2020/0394578 A1
(43) Pub. Date: Dec. 17, 2020

(54) CONTROLLING COMPONENTS OF AN OPERATION USING A PROCESSING SYSTEM

(71) Applicants: Don Lynn Taggart, Edmond, OK (US); Jeremy Daniel Van Dam, Edmond, OK (US); John A. Westerheide, Edmond, OK (US)

(72) Inventors: Don Lynn Taggart, Edmond, OK (US); Jeremy Daniel Van Dam, Edmond, OK (US); John A. Westerheide, Edmond, OK (US)

(73) Assignee: Baker Hughes Oilfield Operations LLC, Houston, TX (US)

(21) Appl. No.: 16/900,025

(22) Filed: Jun. 12, 2020

Related U.S. Application Data
(60) Provisional application No. 62/861,153, filed on Jun. 13, 2019.

(51) Int. Cl. G06Q 10/06; G06F 16/23; G06F 21/31; G06F 21/60; G06Q 10/08

(52) U.S. Cl. CPC G06Q 10/0633; G06F 16/2379; G06K 9/00624; G06F 21/602; G06Q 10/083; G06F 21/31

(57) ABSTRACT

In one example implementation according to aspects of the present disclosure, a system includes an enclosure and a processing system associated with the enclosure. The processing system includes an accelerator, the accelerator being configured to operate in at least one of an activity verification mode or a transaction authentication mode.

### CROSS REFERENCE TO RELATED APPLICATIONS

This application claims the benefit of U.S. Provisional Application Ser. No. 62/861,153, filed on Jun. 13, 2019, the contents of which are incorporated herein in their entirety.

### BACKGROUND

Embodiments described herein relate generally to various operations, including wellbore operations, and more particularly to controlling components of an operation using a processing system.

Energy industry operations such as hydrocarbon exploration employ various systems and operations to accomplish activities including drilling, formation evaluation, stimulation, and production. Various techniques may be employed to facilitate hydrocarbon exploration and production activities.

### BRIEF SUMMARY

Embodiments of the invention described herein provide systems, methods, and computer program products for controlling components of an operation, such as an energy industry operation, using a processing system.

In one embodiment, a system includes an enclosure and a processing system associated with the enclosure. The processing system includes an accelerator, the accelerator being configured to operate in at least one of an activity verification mode or a transaction authentication mode.

In another embodiment, a computer implemented method includes detecting, by a first accelerator of a first processing system, an activity. The method further includes adding, by the first accelerator, a record of the activity to a first digital ledger stored at the first processing system. The method further includes updating, by a second accelerator of a second processing system, a second digital ledger stored at the second processing system to include the record of the activity. The method further includes calculating, by the second accelerator, an encryption key to verify the record. The method further includes responsive to verifying the record, adding, by the second accelerator, the record to a block of the second digital ledger. The method further includes responsive to verifying the record, performing, by the second accelerator, a subsequent action.

In yet another embodiment, a system includes a first energy industry operation component comprising a first edge processing system and a first accelerator, the first accelerator being configured to: detect an activity and add a record of the activity to a first digital ledger stored at the first edge processing system. The system also includes a second energy industry operation component comprising a second edge processing system and a second accelerator, the second accelerator being configured to: update a second digital ledger stored at the second edge processing system to include the record of the activity, calculating, by the second accelerator, an encryption key to verify the record, responsive to verifying the record, adding, by the second accelerator, the record to a block of the second digital ledger, and responsive to verifying the record, performing, by the second accelerator, a subsequent action.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages thereof, are apparent from the following detailed description taken in conjunction with the accompanying drawings in which:

FIG. 1 depicts an edge processing system disposed in an operation component according to one or more embodiments described herein;

FIG. 2 depicts the edge processing system of FIG. 1 associated with operation components according to one or more embodiments described herein;

FIG. 3 depicts a block diagram of the edge processing system of FIG. 1 according to one or more embodiments described herein;

FIG. 4 depicts a block diagram of a network of edge processing systems according to one or more embodiments described herein;

FIG. 5 depicts a flow diagram of a method for image analysis for authenticated lockout according to one or more embodiments described herein;

FIG. 6 depicts a flow diagram of a method for image analysis for performance audit according to one or more embodiments described herein;

FIG. 7 depicts a flow diagram of a method for augmented reality rendering and streaming from an edge processing system according to one or more embodiments described herein; and

FIG. 8 depicts a flow diagram of a method for maintaining records of transactions according to one or more embodiments described herein; and

FIG. 9 depicts a block diagram of a processing system for implementing the techniques described herein according to aspects of the present disclosure.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

A detailed description of one or more embodiments of the disclosed system, apparatus, and method presented herein by way of exemplification and not limitation with reference to the figures. Disclosed are techniques for controlling components of an operation using a processing system, such as an edge processing system. Examples of operations include energy industry operations, such as hydrocarbon exploration and production operations. However, it should be appreciated that the techniques described herein can be applied to other operations beyond the energy industry.

An edge processing system performs processing tasks locally rather than offloading the processing tasks to a remote resource, such as a de-centralized cloud environment. Many tasks that utilize significant processing resources, such as image analysis (e.g., image segmentation and vision analysis), augmented reality rendering and streaming, natural language processing (NLP), and the like, utilize de-centralized cloud environments or other de-centralized processing resources rather than local resources. However, the remote de-centralized approach introduces latency as a result of transmitting data between a local processing system and a remote (cloud) processing system and utilizes large amounts of bandwidth.

In many operations, it may not be possible or feasible to rely on cloud computing environments to perform these processing resource intensive tasks because of the latency and bandwidth concerns. For example, an energy industry operation operating in a rural, remote geographic location might not have any data communication connection or might rely on satellite-based data communication connection. However, satellite-based data communication can be costly (e.g., a satellite provider may charge on a per-byte basis) and can introduce latency. It is therefore desirable to perform processing-intensive tasks, such as image analysis, augmented reality rendering and streaming, natural language processing (NLP), locally to the energy industry operation.

In some environments, it may be desirable to track activities and use information determined from the tracking to authenticate transaction processing. For example, if a delivery is scheduled at an operation, it may be desirable to confirm that the delivery occurred prior to authorizing payment for that delivery. Similarly, if a series of operations are to be performed that depend on one another (e.g., a first operation should be completed prior to a second operation being performed), it may be desirable to authenticate each operation before scheduling the next operation (e.g., schedule the second operation after it is confirmed that the first operation has been performed). For example, at an operation, if a fuel tank is to be delivered by a first provider and filled by a second provider, it may be desirable to confirm that the fuel tank has been delivered before scheduling the second provider to fill the tank. The forgoing example is an example of a smart contract, which is a contract that can be written as a logical or mathematical expression (e.g., if X, do Y; if A and B, then do C, else do D; etc.) and is based upon a ground truth measurement (e.g., an observable activity/event).

The present techniques provide for confirming the ground truth for a smart contract. For example, the present techniques can observe activities at an energy industry operation and confirm whether a particular activity has been performed to satisfy the ground truth of a smart contract. As one such example, if a first company is to deliver a load of sand at an energy industry operation, the present techniques can observe that the sand was delivered and can trigger an event to occur responsive to confirming that the sand was delivered (e.g., scheduling a second company to mix the sand in a blinder to be used for fracturing operations, initiating payment to the first company, etc.). The present techniques utilize image recognition/computer vision to perform ground truth observations and verifications for smart contracts. As another example, if a first company is supposed to deliver a stage to a concert venue and a second company is supposed to install sound and lighting equipment on the stage, the present techniques can be used to verify that the first company installed the stage and then trigger the second company to install the sound and lighting equipment. As yet another example, if a first company is supposed to deliver bricks to a construction site and a second company is supposed to install the bricks, the present techniques can be used to verify that the first company delivered the brinks and then trigger the second company to install the bricks. Additionally, the triggering can trigger payment upon the verification of the ground truth.

Accordingly, the present techniques utilize a processing system having an accelerator to perform processing tasks locally at the energy industry operation, thereby reducing data communication requirements and latency concerns and to provide transaction authentication. Accordingly, the processing system provided herein represents an improvement to energy industry operations and traditional processing systems by performing processing tasks locally using the accelerator at the energy industry operation rather than remotely.

The descriptions provided herein are applicable to various oil and gas or energy industry data activities or operations. Although embodiments herein are described in the context of drilling, completion and stimulation operations, they are not so limited. The embodiments may be applied to any energy industry operation and indeed to operations other than energy industry operations. Examples of energy industry operations include surface or subsurface measurement and modeling, reservoir characterization and modeling, formation evaluation (e.g., pore pressure, lithology, fracture identification, etc.), stimulation (e.g., hydraulic fracturing, acid stimulation), coiled tubing operations, drilling, completion and production. It should be appreciated that the techniques described herein can be applied to other operations beyond the energy industry as well, such as construction operations, event operations, and others.

One or more embodiments described herein leverage advancements in low-power accelerators, such as a graphics processing units (GPU) or another suitable accelerator, to enable processing systems to create an interactive wellsite surveillance, authentication, and optimization platform. Processing systems as described herein, such as edge processing systems, can be installed on virtually any wellsite equipment but would preferentially be installed or retrofitted into a variable speed drive (VSD) or other energy industry operation component (e.g., a heater-treater, a value, a pump, etc.) to provide power and a protective enclosure. In one or more embodiments, the processing system described herein can be implemented as a stand-alone component at an energy industry operation and associated with other energy industry operation components.

According to one or more embodiments of the processing system described herein, a GPU architecture or other accelerator can be used to perform real-time inferencing of a live camera feed(s) on the energy industry operation, allowing the processing system to identify personnel and activities being performed on location. Additionally, the accelerator-based (e.g., GPU-based) processing system can function as an augmented reality server and process voice instructions using NLP, such as for personnel who have been authenticated by facial recognition. In additional examples, the accelerator-based processing system can perform transaction authentication and maintain a ledger of encrypted transactions. By bringing these advanced computing capabilities into the field, processing systems described herein provide significant technical improvement and increased value to oil and gas operators through reduced health, safety, and environmental (HSE) risk, increased personnel efficiency, reduced latency in image processing and augmented reality (AR) rendering and streaming, reduced bandwidth requirements for transmitting data for remote processing, transaction authentication, distributed ledger maintenance, and the like. As used herein, AR refers to graphical information superimposed on a physical environment of the user, sometimes referred to as “mixed reality.”

GPUs offer significant computing power in a small form factor, allowing for a broad range of functionality including performing image recognition/computer vision, natural language processing and artificial intelligence, AR, and data analysis at the processing system.

According to embodiments described herein, the present techniques provide a network of edge processing systems that process transactions according to verification of delivered goods and performed services. Each delivery of a good or performance of a service can be determined using local edge-based accelerators to perform computer vision at the location where the delivery is made or service is performed. In examples, a value of the delivery/service is agreed to by both a provider and recipient prior to performance, and a transaction is automatically processed between the recipient and provider at a time delay and discount rate that is part of an agreement between the parties. The delay and discount can range from zero to some greater value, for example.

Further, according to embodiments described herein, a record of provided goods and services, along with associated transaction data, can be stored on a distributed network of individual data storage and processing machines (referred to as edge processing systems). The same network of edge processing systems calculates cryptographic encryption keys associated with the transactions, thereby maintaining a digital ledger of the transactions. The network of edge processing systems uses accelerators (e.g., GPUs) to perform event detection, transaction processing, and digital ledger maintenance.

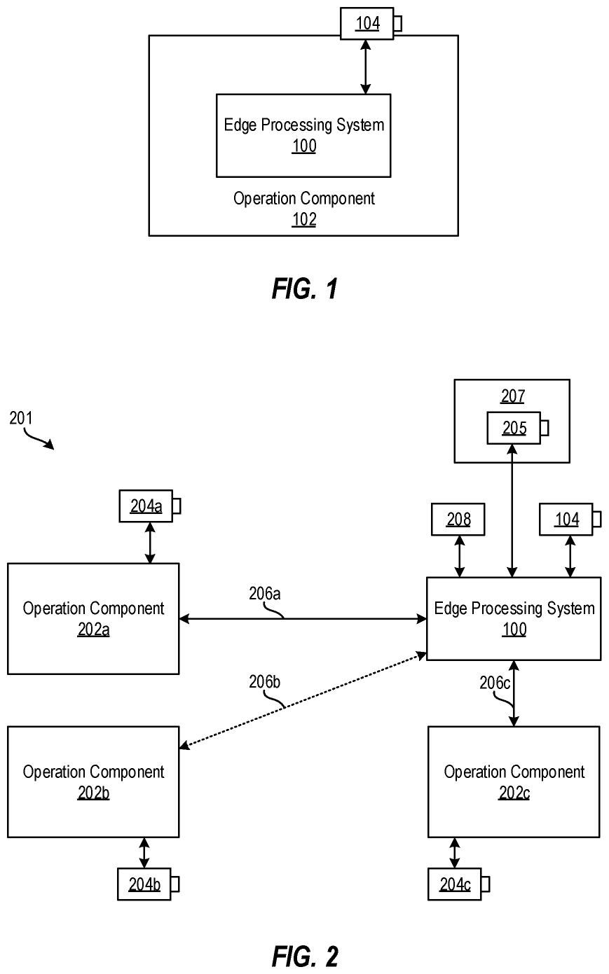

FIG. 1 depicts an edge processing system 100 disposed in an operation component 102 (which can be, for example, an energy industry operation component) according to one or more embodiments described herein. The operation component 102 can include a VSD, a heater-treater, a valve, a pump, a well, a drilling rig, a tank battery, combinations thereof, and the like. The operation component 102 can provide power and a protective enclosure for the edge processing system 100.

The edge processing system 100 is configured to receive an image from a camera 104. For example, the camera 104 can be in wired and/or wireless communication with the edge processing system 100. The camera, for example, captures an image(s) (or video(s)) at the energy industry operation including of personnel, equipment/components/devices, vehicles, and the like. For example, when a delivery is made, when a service is performed, etc., the camera 104 can capture an image(s) or video(s) of the delivery, service, etc. The image(s)/video(s) can be used to perform an image analysis that can be used for authenticated lockout and/or performance audit. Image analysis may include classification using trained neural networks, object detection, image segmentation, and the like.

Also referred to as computer vision, image analysis provides real-time inferencing at the energy industry operation. An example of image analysis includes image segmentation and vision analysis. The image analysis can process images received from cameras around the energy industry operation to authenticate users, verify user certifications, verify proper personal protective equipment (PPE) usage, authenticate transactions, and the like. In some examples, computer vision models can be trained locally at the edge processing system 100 rather than remotely.

According to one or more embodiments described herein, cameras (e.g., the camera 104) powered by the VSD (e.g., the operation component 102) and connected to the edge processing system 100 scan the energy industry operation environment to track and monitor people, equipment, vehicles, components, and the like. When an object (e.g., person, truck, wildlife, etc.) is detected the camera 104 begins capturing and saving images. Using these images, the edge processing system 100 performs image analysis, which includes, for example, drawing a bounding box around object(s) of interest in the images and categorizing the type of the detected object(s) of interest along with the position of the object relative to other objects proximal to the energy industry operation site. If internet and/or other network connectivity is available, a notification can be sent to designated personnel offsite. Image models of authorized personnel can be uploaded onto the edge processing system 100 (remotely with an active connection and/or locally) and used to recognize individuals who visit the site (e.g., pumpers, servicers, etc.). When an individual is recognized, a database query can be made to ensure that the individual is up-to-date on necessary certifications and training. Additionally, the edge processing system 100 can validate proper PPE usage for each person on site using the image analysis. Additionally, the edge processing system 100 can associate time stamps of services being performed at the energy industry operation, such as water hauling or chemical treatments. These timestamps can be used for performance auditing (also referred to as “transaction authentication”) to that a service or other activity has occurred, such as for proper invoicing by service companies, for scheduling additional activities, etc.

According to one or more embodiments described herein, the edge processing system 100 is also configured to perform AR rendering and streaming. For example, once a user is authenticated using computer vision techniques described herein, the edge processing system 100 can be used to render content for AR applications running on a user device, such as a smartphone, tablet, or wearable computing device (e.g., smartglasses, an AR headset, etc.). U.S. Patent Publication No. 2016/0378185, filed on Jun. 23, 2016, and entitled “INTEGRATION OF HEADS UP DISPLAY WITH DATA PROCESSING” describes a wearable information gathering and processing system.

According to one or more embodiments, the AR rendering and streaming can stream technical drawings to the user's device to aid the user in visualizing a component, compare as-designed drawings to as-built equipment, etc. Additionally, AR applications can be used to display real-time sensor data coming from instrumented components on the energy industry operation, such as wellhead pressure and temperature data, tank level data, etc., thus serving as a unified human-machine interface for multiple components on site. Content to be streamed can be stored on a memory or other data storage device, such as a solid state disk or other similar data storage drive, attached to or otherwise associated with the edge processing system 100. This allows for a library of assets and procedures to be stored locally at the energy industry operation without the need for an active internet or network connection. The edge processing system 100 can serve as a local wireless access point to stream content to authenticated users in the vicinity (e.g., at the energy industry operation). Therefore, because the rendering capability of the edge processing system 100 generally far exceeds that of consumer mobile devices, richer and more complex content can be visualized in the field by rendering the AR content on the edge processing system 100 and streaming it to a user's mobile device.

According to one or more embodiments described herein, the edge processing system 100 is also configured to perform natural language processing (NLP). For example, the edge processing system 100 can be used for recognition of keywords/phrases to perform certain tasks on site. For example, a technician wanting to launch an AR application for a maintenance procedure could do so by voice instruction to the edge processing system 100. Additionally, the edge processing system 100 could use NLP technology to respond to/confirm commands, provide instructions, alerts, and reminders to field personnel. For example, a technician could issue a voice command to change an aspect or parameter of the energy industry operation equipment (e.g., “Increase the frequency of the VSD by 2 hertz.”).

According to one or more embodiments described herein, depending on reliability, cost, speed, etc., of a data connection between the edge processing system 100 and a remote processing resource (e.g., a cloud computing environment or other remote processing system (not shown)), the edge processing system 100 can perform some of the computing vision, AR rendering and streaming, and NLP tasks locally and offload other of the tasks to the remote processing resource. The edge processing system 100 can decide which tasks to perform locally and which to offload based on performance demands, priority of the tasks, and the like. For example, at particularly busy times, the edge processing system 100 may offload lower priority tasks (e.g., NLP tasks) to a remote processing resource while performing higher priority tasks (e.g., computer vision tasks).

In some examples, the edge processing system 100 can receive updates to computing vision algorithms, AR applications, NLP libraries, user databases (such as for authorization, training, certification, PPE information, etc.) and the like. Such updates can be received locally, such as from a flash drive or other memory device and/or remotely over a network connection.

According to some examples, the edge processing system 100 can perform performance auditing (also referred to as “transaction authentication”) to verify the occurrence of some event/activity, such as a delivery having been made or service having been provided. For example, delivery of a good or performance of a service can be determined by the edge processing system 100 performing local edge-based computer vision at the energy industry operation where the delivery has been made or where the service has been performed. As an example, a value of a good or service is agreed to between a provider and a receiver, usually prior to the service being performed or delivery being made. The edge processing system 100 can verify the occurrence of the activity (i.e., a delivery or service performance) and then authenticate the occurrence of the activity in a ledger. An invoice can be generated and/or a payment can be transmitted upon the verified occurrence of the activity by the edge processing system 100.

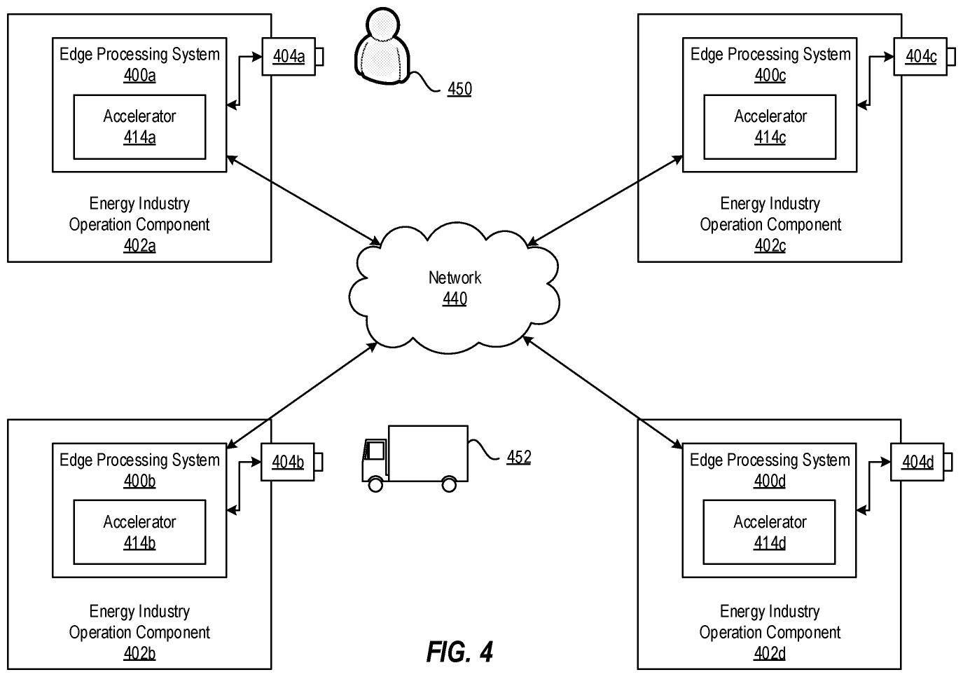

A record of transaction authentication activities, along with any associated transactional data, can be stored on a distributed network of edge processing systems. The network of edge processing systems is described in more detail herein with reference to FIG. 4.

Now turning to FIG. 2, the edge processing system 100 of FIG. 1 associated with operation components 202a, 202b, 202c is depicted according to one or more embodiments described herein. The operation components 202a-202c can be energy industry operation components, for example, or other types of operation components.

In this example, the edge processing system 100 is a separate component from the operation component 202a, 202b, 202c but is communicatively coupled to one or more of the operation component 202a, 202b, 202c. For example, the edge processing system 100 is communicatively coupled to the operation components 202a and 202c by wired communication links 206a and 206c respectively. Similarly, the edge processing system 100 is communicatively coupled to the operation component 202b by a wireless communication link 206b. Similarly, the edge processing system 100 is communicatively coupleable to a user device 208 (e.g., a smartphone, a laptop, a tablet, a wearable computing device such as a smartwatch or headset, etc.), which is associated with a user (not shown).

The operation components 202a, 202b, 202c can be any suitable component, device, or equipment associated with an energy industry operation, such as a VSD, a heater-treater, a pump, etc. Each operation component 202a, 202b, 202c can have a camera (or multiple cameras) associated therewith, including cameras 204a, 204b, 204c respectively. In this way, the edge processing system 100 can receive images from the multiple cameras (e.g., the cameras 104, 205, and 204a-204c) from around the site 201. It should be appreciated that, in examples, one or more of the cameras 104, 205, 204a-204c, are not associated with an energy industry operation component (e.g., the cameras 104, 205). In such examples, a local network of standalone cameras distributed around an energy industry operation (or other industrial operation site) is created. The cameras need not be (but can be) associated with energy industry operation components (e.g., the operation components 202a-202c). In some examples, the cameras 104, 205 are physically separated from such components by a distance (e.g., 1 foot, 8 feet, 10 feet, 15 feet, 40 feet, etc.). In such cases, the cameras can be contained partially or wholly in an enclosure 207 to protect the camera. In some examples, the enclosure 207 is an energy industry operation component (e.g., the operation component 102). By separating the cameras from the energy industry operation components, more costly cameras that are classified for operation in close proximity to components like wellheads, tanks, pumps, etc. can be avoided.

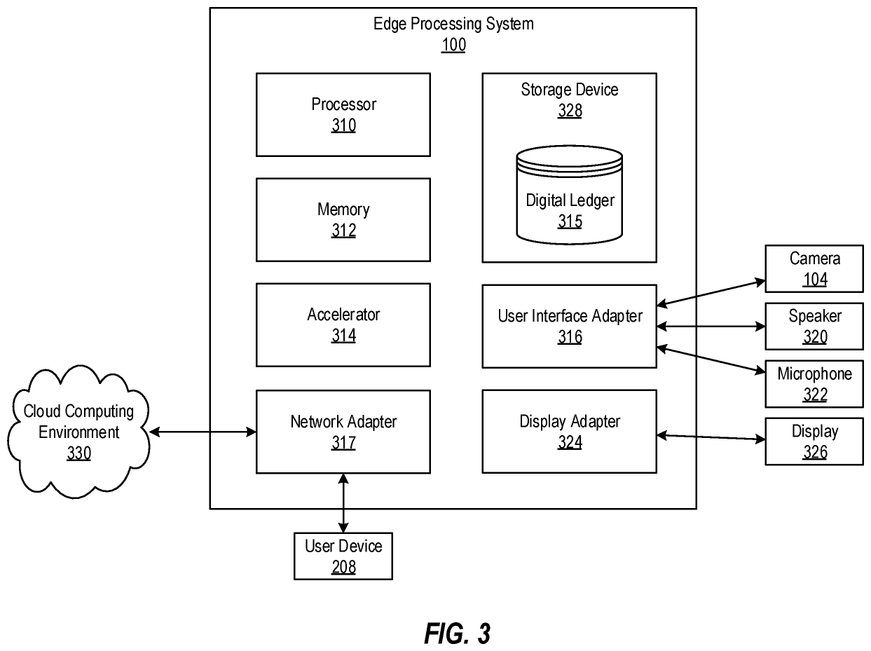

FIG. 3 depicts a block diagram of the edge processing system 100 of FIG. 1 according to one or more embodiments described herein. The edge processing system 100 may include a processor 310 (e.g., a microprocessor, a central processing unit, etc.), a memory 312, an accelerator 314 (e.g., a graphics processing unit (GPU)), a network adapter 317, a storage device 328 (e.g., a solid state drive, a hard disk drive, a flash memory, a non-volatile memory, etc.), a user adapter interface 316, and a display adapter 324. The storage device 328 can store, among other things, a digital ledger 315, which maintains transaction records.

The network adapter 317 can communicatively couple to other devices, such as a cloud computing environment 330, the user device 208, other edge processing systems (e.g., the edge processing systems 400a, 400b, 400c, 400d of FIG. 4), etc. via one or more wired and/or wireless network(s). The user interface adapter 316 is configured to transmit data to and receive data from various devices, such as the camera 104, the cameras 204a-204c, a speaker 320, a microphone 322, and the like. In examples, the user interface adapter 316 is configured to transmit and/or receive any locally (i.e., from the operation component 102 or another suitable component) available analog or digital data signals, such as pressure, temperature, flowrate, or other equipment operating parameter measurements. The display adapter 324 transmits image data to a display 326.

FIG. 4 depicts a block diagram of a network of edge processing systems 400a, 400b, 400c, 400d (collectively referred to as the “edge processing systems 400”) according to one or more embodiments described herein. One or more of the edge processing systems 400 can be configured to include the components shown in FIG. 3 and described herein. For example, one or more of the edge processing systems 400 can include accelerators. As shown in FIG. 4, the edge processing system 400a includes an accelerator 414a, the edge processing system 400b includes an accelerator 414b, the edge processing system 400c includes an accelerator 414c, and the edge processing system 400d includes an accelerator 414d. Collectively, the accelerators 414a-414d are referred to as the “accelerators 414.”

The edge processing systems 400 are disposed in energy industry operation components. For example, the edge processing system 400a is disposed in the energy industry operation component 402a. Similarly, the edge processing systems 400b, 400c, and 400d are disposed respectively in the energy industry operation components 402b, 402c, and 402d. Collectively, the energy industry operation components 402a-402d are referred to as the “energy industry operation components 402.” The energy industry operation components 402 can be a VSD, a heater-treater, a valve, a pump, combinations thereof, and the like. The energy industry operation components 402 can provide power and a protective enclosure for their respective edge processing systems 400.

The edge processing systems 400 are communicatively coupled together to form a network 440. The network can be a public network, a private network, a local area network (LAN), a wide area network (WAN), a wireless network, a wired network, a Bluetooth network, or another suitable network, or combinations thereof. For example, one or more of the edge processing systems 400 can be connected by network cables to other(s) of the edge processing systems 400; similarly, another of the edge processing systems 400 can be connected wirelessly to other(s) of the edge processing systems 400. It should be appreciated that different types and configurations of communication protocols and techniques can be used to enable the edge processing systems 400 to communicate. Accordingly, when so communicatively coupled, the edge processing systems 400 are said to form a distributed network.

The edge processing systems 400, individually and or collectively in any suitable combination, can perform activity verification (in an activity verification mode) and/or transaction authentication (in a transaction authentication mode) using their respective accelerators 414. Activity verification includes, for example, authenticated lockout determination or performance audit. Transaction authentication includes, for example, authenticating a transaction by determining that an activity (e.g., a service or delivery) has occurred, maintaining a digital ledger of activities including the activity, and facilitating a subsequent action (e.g., payment of an invoice, scheduling of another activity, etc.).

In the case of activity verification, one or more of the edge processing systems 400 verify an activity being performed at an energy industry operation. In examples, verification for the authentication of transactions can be performed based at least in part on visual and/or non-visual indicators. An example of a visual indicator includes visually detecting a service being performed at the energy industry operation, a delivery being made at the energy industry operation, etc. The verification is performed by the accelerator of the respective edge processing system using image analysis based at least in part on image data received from a camera associated with the processing system. As an example, a service 450 or a delivery 452 can be detected and verified by the accelerators 414a, 414b respectively using image data captured from the cameras 404a, 404b respectively. An example of a non-visual indicator used to verify an activity being performed can include detection of a programmable logic controller that is communicatively coupled to an accelerator (e.g., one of the accelerators 414a, 414b, etc.), detection of a tank level change using a tank level sensor that changes with the arrival of a vacuum truck, detection of an inputted authentication (e.g., a passcode, a key, a biometric identifier, etc.) associated with a lockout/tagout system or other suitable system, etc.

In the case of transaction authentication, the accelerator (e.g., the accelerator 414a) verifies that an activity has occurred, for example, using image analysis. The accelerator then updates its digital ledger (e.g., the digital ledger 315) and facilitates a subsequent action, which can include scheduling a delivery or service to be performed, initiating a transfer of an asset (such as payment of funds), and the like.

In some environments, the network 440 may be subjected to interruptions or outages such that one or more of the edge processing systems 400 have intermittent connectivity to the other of the edge processing systems. Accordingly, it may be desirable to maintain a local ledger at each of the edge processing systems 400 and a global (distributed) ledger among the edge processing systems 400. This enables one of the edge processing systems 400 to continue to add records of activities to its local ledger in the event its network connection is interrupted. When the network connection is reestablished, the records stored in the local ledger can be used to update the global ledger distributed among the other edge processing systems 400.

According to one or more embodiments described herein, the accelerator 414 operates in the transaction authentication mode until an interrupt is received. Upon receipt of the interrupt, the accelerator operates in the activity verification mode to perform activity verification. The accelerator then returns to the transaction authentication mode responsive to completing the activity verification.

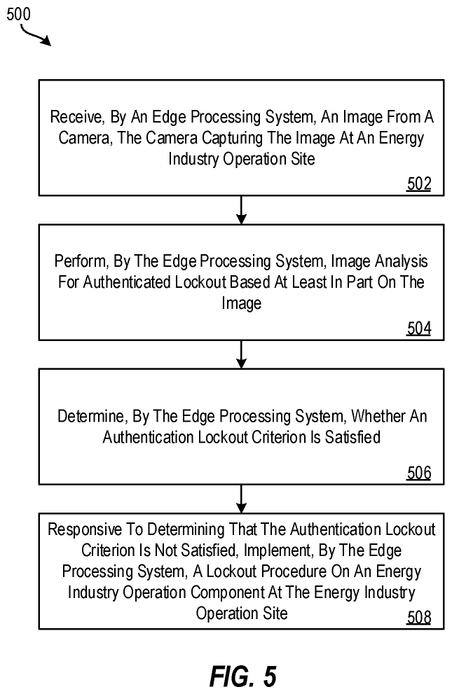

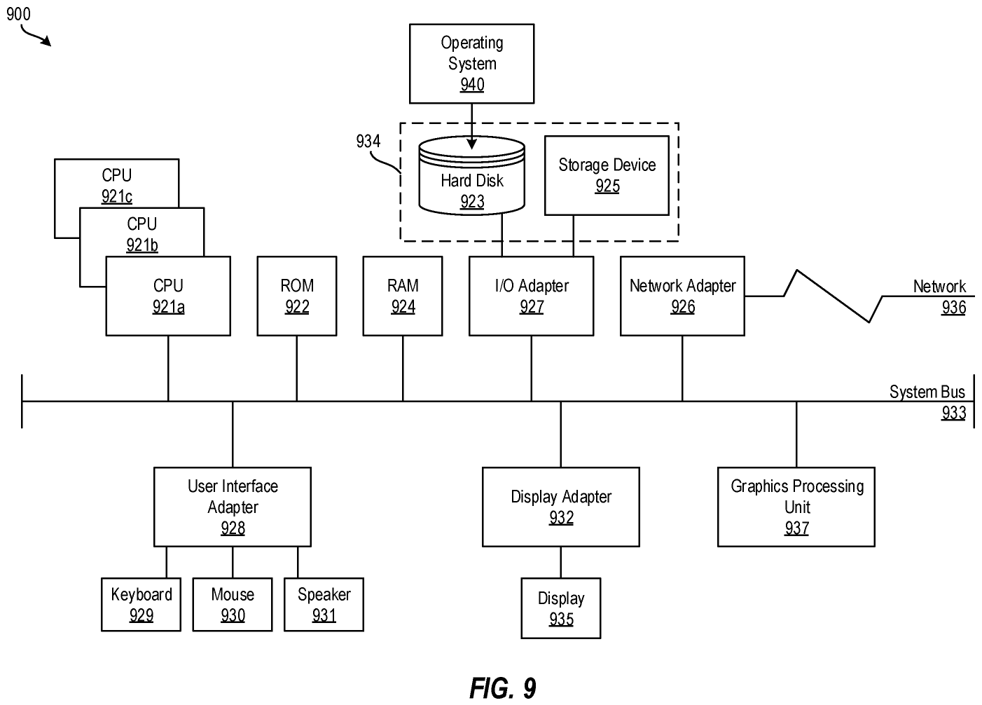

The functionality of the edge processing system 100 and its components, as well as the edge processing systems 400 and their components, are now described with reference to FIGS. 5, 6, 7, and 8. In particular, FIG. 5 depicts a flow diagram of a method for image analysis for authenticated lockout according to one or more embodiments described herein. The method 500 can be performed by any suitable processing system and/or processing device, such as the edge processing system 100 of FIGS. 1-3, one or more of the edge processing systems 400 of FIG. 4, and/or the processing system 900 of FIG. 9.

At block 502, the edge processing system 100, comprising the accelerator 314, receives an image from the camera 104 (or another camera) or from multiple cameras (e.g., cameras 204a-204c). The camera 104 captures the image at the energy industry operation site 201.

At block 504, the edge processing system 100 performs image analysis for authenticated lockout based at least in part on the image received from the camera 104. The image analysis can include image segmentation, which partitions a digital image into segments, which are sets of pixels, in order to simplify an image so that it is easier to analyze. Image segmentation enables objects and boundaries to be detected/determined. In this way, image analysis can identify features in images, such as faces, vehicles, equipment, actions, objects, and the like.

At block 506, the edge processing system 100 determines whether an authentication lockout criterion is satisfied. Examples of authentication lockout criteria include whether a user is an authorized user (determined by performing facial recognition on an image of the user and comparing against an authorized user database), whether the user is properly trained/certified (determined by performing facial recognition on an image of the user and comparing against a training/certification database), whether the user is properly equipped with PPE (determined by performing object recognition on an image of the user to detect PPE, such as a hard hat, safety glasses, steel-toed boots, etc., and comparing the identified PPE against a database of required PPE for the energy industry operation site), whether a require minimum of individuals are present (e.g., determine whether at least two trained and certified technicians are present for a job that requires two such technicians), determine whether an unauthorized device is being used (e.g., a cheater bar), whether the user is performing an unsafe act (e.g., determine whether the user is using a tool improperly, changing a setting on a component to an unsafe level, attempting to access a component that the user is not authorized to access), and the like. In some examples, a lockout criterion is that the energy industry operation component is in a high energy state. For example, if the VSD is energized with a high voltage power source, it may remain locked out to a user even if the user is authorized, trained, certified, and the like, in order to protect the user and prevent the user from accessing the VSD while it is in the high energy state.

At block 508, if it is determined that the authentication lockout criterion is not satisfied, a lockout procedure is implemented on an energy industry operation component at the energy industry operation site. The lockout procedure can include activating a physical lock on the operation component 102 (or other equipment), preventing a physical lock on the operation component 102 (or other equipment) from being unlocked, restricting what access the user has (e.g., if a user is not certified to access the VSD but is certified to operate a pump, preventing access to the VSD but authorizing access to the pump), etc. That is, if at block 506 it is determined that the authentication lockout criterion is satisfied, then the edge processing system 100 grants access to an energy industry operation component at the energy industry operation site.

Additional processes also may be included, and it should be understood that the process depicted in FIG. 5 represents an illustration, and that other processes may be added or existing processes may be removed, modified, or rearranged without departing from the scope and spirit of the present disclosure.

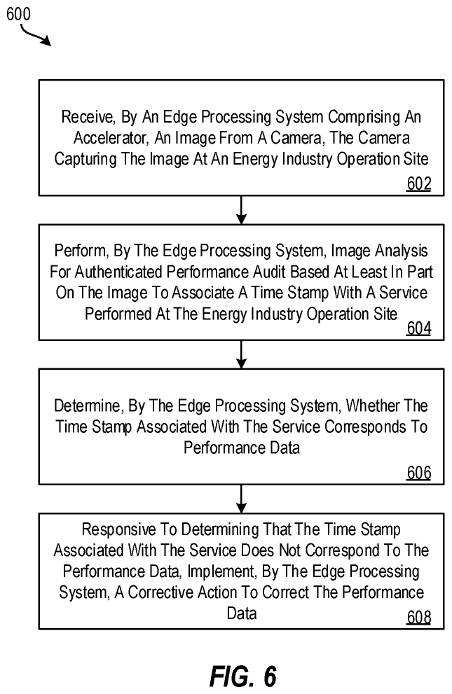

Turning now to FIG. 6, this figure depicts a flow diagram of a method for image analysis for performance audit according to one or more embodiments described herein. The method 600 can be performed by any suitable processing system and/or processing device, such as the edge processing system 100 of FIGS. 1-3, one or more of the edge processing systems 400 of FIG. 4, and/or the processing system 900 of FIG. 9.

At block 602, the edge processing system 100, comprising the accelerator 314, receives an image from the camera 104 (or another camera). The camera 104 captures the image at the energy industry operation site 201.

At block 604, the edge processing system 100 performs image analysis for authenticated performance audit based at least in part on the image to associate a time stamp with a service performed at the energy industry operation site. For example, the edge processing system 100 analyses an image or images to detect when a service technician arrives on site and when the technician departs from the site. The edge processing system 100 can associate time stamps with the arrival and departure to determine how long the technician is at the site 201.

At block 606, the edge processing system 100 determines whether the time stamp(s) associated with the service (e.g., how long the technician is at the site 201) corresponds to performance data. The performance data can be, for example, an employee's recorded service hours, invoice data, and the like.

At block 608, if it is determined at block 606 that the time stamp associated with the service does not correspond to the performance data, the edge processing system 100 can implement a corrective action to correct the performance data. For example, the edge processing system 100 can adjust (or cause to be adjusted) an invoice to correct any discrepancy between the performance data of the invoice against actual service time that the technician was at the site 201. The present techniques can also account for breaks or other non-working time that the technician is at the site 201 but not performing a service that is indicated in the performance data. Similarly, the present techniques can detect a service that is performed but not reflected in the performance data. For example, an invoice can be corrected to include a service that was actually performed but not recorded on the invoice (i.e., performance data).

In some examples, the edge processing system 100 can track a servicer and a vehicle associated with the servicer separately. For example, the edge processing system can determine when the vehicle arrives to and departs from the site 201. The edge processing system 100 can identify a vehicle, for example, by an indicium on the vehicle such as a logo/sign, a license plate, a barcode, a radio frequency identifier (RFID) tag, a QR code, or another indicator. Similarly, the edge processing system 100 can track a servicer around the site 201 by tracking an indicium associated with the servicer, by using facial recognition of the servicer, etc. In this way, the edge processing system 100 can segment both temporally and spatially.

As one such example implementation of the method 600, a schedule of wellsite operations for a particular month (i.e., December) is uploaded to the edge processing system 100, either remotely or locally. This includes the planned inspection of holding tank levels and heater-treater state by authorized servicers (i.e., “pumpers”). Then, when a pumper shows up and the activities of that pumper are identified by the edge processing system 100 during the pumper's visit, discrepancies can be identified. If the pumper fails to show up at the site 201 or fails to check tank levels (e.g., the pumper is identified as staying in his vehicle the entire time of his visit and is not observed as leaving his vehicle or checking tank levels), these activities/events can be logged, and the consequences of these activities/events (e.g., spilling tanks, failing heater-treaters, unplanned artificial lift shutdowns, explosions, etc.) can be reduced or eliminated.

Additional processes also may be included, and it should be understood that the process depicted in FIG. 6 represents an illustration, and that other processes may be added or existing processes may be removed, modified, or rearranged without departing from the scope and spirit of the present disclosure.

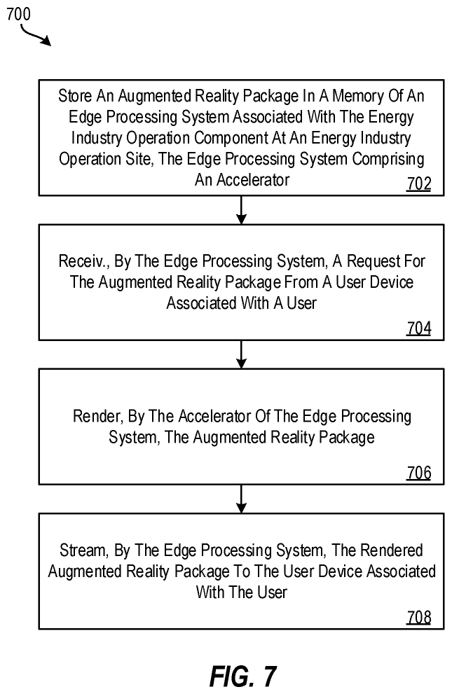

Turning now to FIG. 7, this figure depicts a flow diagram of a method for augmented reality rendering and streaming from an edge processing system according to one or more embodiments described herein. The method 700 can be performed by any suitable processing system and/or processing device, such as the edge processing system 100 of FIGS. 1-3, one or more of the edge processing systems 400 of FIG. 4, and/or the processing system 900 of FIG. 9.

At block 702, an augmented reality package is stored in the memory 312 of the edge processing system 100 associated with the operation component 102 at the energy industry operation site 201. The augmented reality package can include as-designed drawings/diagrams, as-built drawings/diagrams, exploded views of components/equipment, and the like.

At block 704, the edge processing system 100 receives a request for the augmented reality package from a user device 208 associated with a user. According to one or more embodiments described herein, the user is located at the energy industry operation site 201, such as within a wireless networking range of the edge processing system 100.

At block 706, the edge processing system 100, utilizing the accelerator 314, renders the augmented reality package.

At block 708, the edge processing system 100 streams the rendered augmented reality package to the user device 208 associated with the user. For example, the rendered augmented reality package can be presented to the user on the user device 208, which can include a display for viewing the augmented reality package. The user device 208 can include a smartphone, a laptop, a tablet, a wearable computing device such as a smartwatch or a headset, and the like.

The edge processing system 100 can also stream the rendered augmented reality package to a remote user to enable the remote user and the user (who is considered a local, with respect to the edge processing system 100, user). In this way, the local user and the remote user can view the augmented reality package concurrently, which can improve troubleshooting and maintenance. For example, a remote expert can guide a local technician to troubleshoot and perform maintenance on the operation component 102 (or another component or device).

Additional processes also may be included, and it should be understood that the process depicted in FIG. 7 represents an illustration, and that other processes may be added or existing processes may be removed, modified, or rearranged without departing from the scope and spirit of the present disclosure.

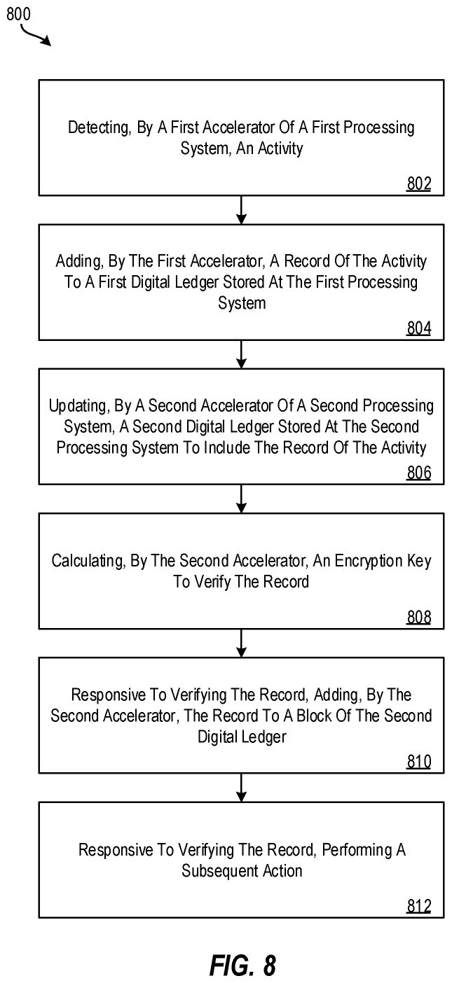

FIG. 8 depicts a flow diagram of a method 800 for maintain records of transactions according to one or more embodiments described herein. The method 800 can be performed by any suitable processing system and/or processing device, such as the edge processing system 100 of FIGS. 1-3, one or more of the edge processing systems 400 of FIG. 4, and/or the processing system 900 of FIG. 9.

At block 802, a first accelerator of a first processing system detects an activity. For example, with reference to FIG. 4, the camera 404a associated with the edge processing system 400a and/or the camera 404b associated with the edge processing system 400b detects an activity. For example, detecting the activity can include the accelerator 414a verifying an activity (i.e., a service 450) being performed at an energy industry operation. As another example, detecting the activity can include the accelerator 414b verifying an activity (i.e., a delivery 452) being performed at the energy industry operation. Verifying the activity can be performed using image analysis based at least in part on image data received from a camera associated with the first processing system. This verification acts as the ground truth observation and verification for smart contracts as described herein.

At block 804, accelerator (e.g., the accelerator 414a for the service 450 or the accelerator 414b for the delivery 452) adds a record of the activity to a digital ledger stored at the respective processing system 402a or 404b for example. The record has an associated encryption key to protect the record from unauthorized authorization and to enable the record to be verified, such as by calculating the encryption key to determine a match and thus verification of the record.

At block 806, another accelerator of the distributed network of edge processing systems 400 updates a digital ledger stored at its processing system to include the record of the activity. For example, the accelerator 414c updates a digital ledger stored at its edge processing system 400c to include the record of the activity detected by the accelerator 414a (i.e., the service 450) and/or the record of the activity detected by the accelerator 414b (i.e., the delivery 452). Similarly, as another example, the accelerator 414d updates a digital ledger stored at its edge processing system 400d to include the record of the activity detected by the accelerator 414a (i.e., the service 450) and/or the record of the activity detected by the accelerator 414b (i.e., the delivery 452). The accelerators 414a, 414b can also update digital ledgers stored at their respective edge processing systems 400d accordingly. It should be appreciated that not all of the accelerators 414 need to maintain or update digital ledgers but they can be so enabled.

At block 808, the other accelerator calculates an encryption key to verify the record. Encryption keys can be calculated in different ways, such as by using symmetric algorithms and asymmetric algorithms.

Responsive to verifying the record at block 808, the other accelerator adds the record to a block of its digital ledger at block 810. In this way, the digital ledgers across a distributed network of edge processing systems (see the example of FIG. 4) can maintain records of transactions performed at the energy industry operation.

At block 812, responsive to verifying the record, a subsequent action is performed, such as by the other accelerator (or the edge processing system associated with the other accelerator) or another suitable device or system. Examples of subsequent action can include authorizing an invoice to be paid, transferring an asset such as transmitting a payment (e.g., automatically initiate a wire transfer, a cryptocurrency transfer, etc.), scheduling a service to be performed and/or a delivery to be made, and the like and combinations thereof.

Advantages of the presently described techniques are numerous. For example, the present techniques leverage computer vision technology to reduce HSE risk, to authenticate transactions, and perform other suitable tasks. The edge processing system 100 can recognize personnel on location (and generate alerts for trespassers) and ensure that each identified person is properly trained/certified. Identified personnel can also be screened for proper PPE, including hard hats and safety glasses, to verify personnel are using the proper controls and catch any habitual policy offenders.

Another advantage of the presently described techniques is that the edge processing system 100 can optimize and improve the performance of energy industry operations. For example, the edge processing system 100 can synthesize data from a VSD and other sensors (e.g., pressure, temperature, etc.) at the energy industry operation. Further, the edge processing system 100 can run analytics and/or prognostics based on collected data and potentially adjust parameters in real-time, serving as a “nerve center” of the energy industry operation.

Yet another advantage of the presently described techniques is that the edge processing system 100 can create and improve personnel efficiency with localized AR rendering and natural language processing. The edge processing system 100 can function as a field AR rendering and streaming server, facilitating applications for maintenance, asset schematics/cutaways, and facilitating remote troubleshooting sessions between the field worker and an office-based expert. Additionally, the edge processing system 100 can serve as a unified source for data consumption through an AR application, replacing the individual human-machine interfaces for each component or sensor on the wellsite and integrating it into a single AR application to expedite review.

Another advantage of the presently described techniques is that the edge processing system 100 can monitor activities at the energy industry operation site to ensure proper invoicing. For example, the edge processing system 100 can use computer vision to determine the timestamps of trucks entering and leaving the energy industry operation site. This provides a record of transactions and services occurring on the energy industry operation site that can be audited by comparing against invoicing data (also referred to as performance data). The edge processing systems can also authenticate transactions as described herein and maintain ledgers of records of those transactions across a distributed network of edge processing systems. Accordingly, the present techniques eliminate the need for manual logging of goods and service delivery, eliminate the need for submission of receipt logs or invoices, eliminates the need for a provider to maintain separate logs, eliminates the arbitrator or reconciliation of discrepancies between provider and recipient logs, and eliminates the cost and delays associated with processing payments between senders and receivers. The present techniques also leverage the same distributed data storage and processing resources that are used or performing computer vision based event verification. These resources are well-suited for computing the encryption keys necessary to maintain the digital ledger. Another advantage offered by the present techniques is the network of data storage and computation devices distributed across numerous oilfield locations. This network enables detection of goods and service delivery without the cost of image data transmission to a cloud computing environment. This network also provides the distributed computational resources required to maintain a cryptographically secured digital ledger.

It is understood that the present disclosure is capable of being implemented in conjunction with any other type of computing environment now known or later developed. For example, FIG. 9 depicts a block diagram of a processing system 900 for implementing the techniques described herein. In examples, processing system 900 has one or more central processing units (processors) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to system memory (e.g., random access memory (RAM) 924) and various other components via a system bus 933. Read only memory (ROM) 922 is coupled to system bus 933 and may include a basic input/output system (BIOS), which controls certain basic functions of processing system 900.

Further depicted are an input/output (I/O) adapter 927 and a network adapter 926 coupled to system bus 933. I/O adapter 927 may be a small computer system interface (SCSI) adapter that communicates with a hard disk 923 and/or a storage device 925 or any other similar component. I/O adapter 927, hard disk 923, and storage device 925 are collectively referred to herein as mass storage 934. Operating system 940 for execution on processing system 900 may be stored in mass storage 934. The network adapter 926 interconnects system bus 933 with an outside network 936 enabling processing system 900 to communicate with other such systems.

A display (e.g., a display monitor) 935 is connected to system bus 933 by display adapter 932, which may include a graphics adapter to improve the performance of graphics intensive applications and a video controller. In one aspect of the present disclosure, adapters 926, 927, and/or 932 may be connected to one or more I/O busses that are connected to system bus 933 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/O chip integrating multiple device adapters into a single integrated circuit.

In some aspects of the present disclosure, processing system 900 includes a graphics processing unit 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing, and has a highly parallel structure that makes it more effective than general-purpose CPUs for algorithms where processing of large blocks of data is done in parallel.

Thus, as configured herein, processing system 900 includes processing capability in the form of processors 921, storage capability including system memory (e.g., RAM 924), and mass storage 934, input means such as keyboard 929 and mouse 930, and output capability including speaker 931 and display 935. In some aspects of the present disclosure, a portion of system memory (e.g., RAM 924) and mass storage 934 collectively store the operating system 940 to coordinate the functions of the various components shown in processing system 900.

Set forth below are some embodiments of the foregoing disclosure:

### Embodiment 1

A system comprising: an enclosure; and a processing system associated with the enclosure, the processing system comprising an accelerator, the accelerator being configured to operate in at least one of an activity verification mode or a transaction authentication mode.

### Embodiment 2

A system of one or more previous embodiments, wherein, when operating in the activity verification mode, the accelerator verifies an activity being performed at an energy industry operation, the activity being at least one of a service being performed at the energy industry operation or a delivery being made at the energy industry operation.

### Embodiment 3

A system of one or more previous embodiments, wherein the verification is performed by the accelerator using image analysis based at least in part on image data received from a camera associated with the processing system.

### Embodiment 4

A system of one or more previous embodiments, wherein, when operating in the transaction authentication mode, the accelerator verifies that an activity has occurred, updates a digital ledger, and facilitates a subsequent action.

### Embodiment 5

A system of one or more previous embodiments, wherein the digital ledger is maintained by a plurality of processing systems, each of the plurality of processing systems comprising an accelerator.

### Embodiment 6

A system of one or more previous embodiments, wherein the accelerator operates in the transaction authentication mode until an interrupt is received, wherein the accelerator operates in the activity verification mode responsive to receiving the interrupt, and wherein the accelerator returns to the transaction authentication mode responsive to completing the activity verification.

### Embodiment 7

A system of one or more previous embodiments, wherein the enclosure is an energy industry operation component.

### Embodiment 8

A computer-implemented method comprising: detecting, by a first accelerator of a first processing system, an activity; adding, by the first accelerator, a record of the activity to a first digital ledger stored at the first processing system; updating, by a second accelerator of a second processing system, a second digital ledger stored at the second processing system to include the record of the activity; calculating, by the second accelerator, an encryption key to verify the record; responsive to verifying the record, adding, by the second accelerator, the record to a block of the second digital ledger; and responsive to verifying the record, performing, by the second accelerator, a subsequent action.

### Embodiment 9

A computer-implemented method of one or more previous embodiments, wherein detecting the activity comprises verifying, by the first accelerator, an activity being performed at an energy industry operation.

### Embodiment 10

A computer-implemented method of one or more previous embodiments, wherein verifying the activity is performed using image analysis based at least in part on image data received from a camera associated with the first processing system.

### Embodiment 11

A computer-implemented method of one or more previous embodiments, wherein the second ledger comprises a local ledger and a global ledger.

### Embodiment 12

A computer-implemented method of one or more previous embodiments, wherein the second accelerator adds the record to a block of the local ledger and to a block of the global ledger responsive to verifying the record.

### Embodiment 13

A computer-implemented method of one or more previous embodiments, wherein second accelerator adds the record to a block of the local ledger responsive to verifying the record and wherein the second accelerator adds the record to a block of the global ledger responsive to verifying the record and responsive to establishing a communication link to another accelerator.

### Embodiment 14

A computer-implemented method of one or more previous embodiments, a first energy industry operation component comprising a first edge processing system and a first accelerator, the first accelerator being configured to: detect an activity, and add a record of the activity to a first digital ledger stored at the first edge processing system; and a second energy industry operation component comprising a second edge processing system and a second accelerator, the second accelerator being configured to: update a second digital ledger stored at the second edge processing system to include the record of the activity, calculating, by the second accelerator, an encryption key to verify the record, responsive to verifying the record, adding, by the second accelerator, the record to a block of the second digital ledger, and responsive to verifying the record, performing, by the second accelerator, a subsequent action.

### Embodiment 15

A system of one or more previous embodiments, wherein the first energy industry operation component comprises a camera communicatively coupled to the first edge processing system to capture image data, wherein detecting the even comprises by verifying, by the first accelerator, an activity being performed at an energy industry operation, wherein verifying the activity is performed using image analysis based at least in part on the image data received from the camera.

### Embodiment 16

A system of one or more previous embodiments, wherein performing the subsequent action comprises at least one of scheduling a delivery, scheduling a service to be performed, and automatically initiating a transfer of an asset.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The term “coupled” relates to a first component being coupled to a second component either directly or indirectly via an intermediary component. The term “configured” relates to one or more structural limitations of a device that are required for the device to perform the function or operation for which the device is configured.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While one or more embodiments have been shown and described, modifications and substitutions may be made thereto without departing from the spirit and scope of the invention. Accordingly, it is to be understood that the present invention has been described by way of illustrations and not limitation.

It will be recognized that the components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system comprising:
an enclosure; and
a processing system associated with the enclosure, the processing system comprising an accelerator, the accelerator being configured to operate in at least one of an activity verification mode or a transaction authentication mode.

2. The system of claim 1, wherein, when operating in the activity verification mode, the accelerator verifies an activity being performed at an operation, the activity being at least one of a service being performed at the operation or a delivery being made at the energy industry operation.

3. The system of claim 2, wherein the verification is performed by the accelerator using image analysis based at least in part on image data received from a camera associated with the processing system.

4. The system of claim 1, wherein, when operating in the transaction authentication mode, the accelerator verifies that an activity has occurred, updates a digital ledger, and facilitates a subsequent action.

5. The system of claim 4, wherein the digital ledger is maintained by a plurality of processing systems, each of the plurality of processing systems comprising an accelerator.

6. The system of claim 1, wherein the accelerator operates in the transaction authentication mode until an interrupt is received, wherein the accelerator operates in the activity verification mode responsive to receiving the interrupt, and wherein the accelerator returns to the transaction authentication mode responsive to completing the activity verification.

7. The system of claim 1, wherein the enclosure is an energy industry operation component.

8. A computer-implemented method comprising:
detecting, by a first accelerator of a first processing system, an activity;
adding, by the first accelerator, a record of the activity to a first digital ledger stored at the first processing system;
updating, by a second accelerator of a second processing system, a second digital ledger stored at the second processing system to include the record of the activity;
calculating, by the second accelerator, an encryption key to verify the record;
responsive to verifying the record, adding, by the second accelerator, the record to a block of the second digital ledger; and
responsive to verifying the record, performing, by the second accelerator, a subsequent action.

9. The computer-implemented method of claim 8, wherein detecting the activity comprises verifying, by the first accelerator, an activity being performed at an energy industry operation.

10. The computer-implemented method of claim 9, wherein verifying the activity is performed using image analysis based at least in part on image data received from a camera associated with the first processing system.

11. The method of claim 8, wherein the second ledger comprises a local ledger and a global ledger.

12. The method of claim 11, wherein the second accelerator adds the record to a block of the local ledger and to a block of the global ledger responsive to verifying the record.

13. The method of claim 12, wherein second accelerator adds the record to a block of the local ledger responsive to verifying the record and wherein the second accelerator adds the record to a block of the global ledger responsive to verifying the record and responsive to establishing a communication link to another accelerator.

14. A system comprising:
a first energy industry operation component comprising a first edge processing system and a first accelerator, the first accelerator being configured to:
detect an activity, and
add a record of the activity to a first digital ledger stored at the first edge processing system; and
a second energy industry operation component comprising a second edge processing system and a second accelerator, the second accelerator being configured to:
update a second digital ledger stored at the second edge processing system to include the record of the activity,
calculating, by the second accelerator, an encryption key to verify the record,
responsive to verifying the record, adding, by the second accelerator, the record to a block of the second digital ledger, and
responsive to verifying the record, performing, by the second accelerator, a subsequent action.

15. The system of claim 14, wherein the first energy industry operation component comprises a camera communicatively coupled to the first edge processing system to capture image data, wherein detecting the even comprises by verifying, by the first accelerator, an activity being performed at an energy industry operation, wherein verifying the activity is performed using image analysis based at least in part on the image data received from the camera.

16. The system of claim 14, wherein performing the subsequent action comprises at least one of scheduling a delivery, scheduling a service to be performed, and automatically initiating a transfer of an asset.
